(19) United States
(12) Patent Application Publication
(10) Pub. No.: US 2011/0279606 A1
(43) Pub. Date: Nov. 17, 2011

(54) LIQUID EJECTING UNIT AND LIQUID EJECTING APPARATUS

(75) Inventors: Satoshi Oguchi, Okaya-shi (JP); Toru Nagate, Matsumoto-shi (JP)

(73) Assignee: Seiko Epson Corporation, Shinjuku-ku (JP)

(21) Appl. No.: 13/103,816

(22) Filed: May 9, 2011

(30) Foreign Application Priority Data
May 11, 2010 (JP) 2010-109038

(51) Int. Cl. B41J 2/175

(52) U.S. Cl. 347/93

(57) ABSTRACT

The invention provides a liquid ejecting unit and a liquid ejecting apparatus that can prevent the film of the damper flow passage member from wrinkling. In a surface of a damper flow passage member covered with a film, a communication passage, a first filter chamber in which a first filter is disposed, and an empty chamber disposed between a pressure chamber and the communication passage are provided. The film is attached to a surface of each of the pressure chamber, the empty chamber, and the communication passage so as to cover a first flow passage and a second flow passage with the empty chamber therebetween. In a region of the film facing the empty chamber, a weak portion is formed that permits the stretching of the film.

### CROSS-REFERENCE TO RELATED APPLICATIONS

This application claims the benefit of priority to Japanese Patent Application No. 2010-109038 filed May 11, 2010, the contents of which are hereby incorporated by reference in their entirety.

### BACKGROUND

1. Technical Field

The present invention relates to a liquid ejecting unit and a liquid ejecting apparatus having a liquid ejecting head such as an ink jet recording head.

2. Related Art

Examples of liquid ejecting heads that discharge liquid droplets from nozzles by causing a pressure change in the liquid in pressure chambers include: an ink jet recording head (hereinafter simply referred to as recording head) used in an image recording apparatus such as an ink jet recording apparatus (hereinafter simply referred to as printer); a color material ejecting head used for manufacturing a color filter of a liquid crystal display or the like; an electrode material ejecting head used for forming electrodes of an organic EL (Electro Luminescence) display, an FED (field emission display), or the like; and a bioorganic material ejecting head used for manufacturing biochips (biochemical elements).

For example, in the above recording head, ink in an ink cartridge (a kind of liquid supply source, hereinafter simply referred to as cartridge) in which liquid ink is enclosed is introduced into the pressure chambers through a reservoir (common liquid chamber) of the recording head. Pressure generators such as piezoelectric vibrators or heater elements are driven, and a pressure change is caused in the ink in the pressure chambers. Using this pressure change, ink is ejected from nozzles communicating with the pressure chambers. Some of recording heads having this configuration are combined with a flow passage forming member (also referred to as self-sealing unit or damper flow passage member) provided in a flow passage that supplies ink from the cartridge to the recording head, and form an ink ejecting head unit (see, for example, JP-A-2009-184202). This flow passage forming member has an on-off valve (also referred to as self-sealing valve) provided in a flow passage inside it. A part of the flow passage is sealed with a thin film. Ink droplets are ejected from the nozzles of the recording head, and a negative pressure is thereby created inside the reservoir. The film bends so as to push open the on-off valve, and the on-off valve is thereby opened. Thus, ink is supplied from the ink cartridge to the reservoir of the recording head.

In addition, the flow passage forming member has a filter disposed in the flow passage in order to prevent foreign substances and bubbles in the flow passage from flowing into the recording head. There has been proposed a recording head in which, when a filter chamber on the upstream side of a filter is depressurized in a cleaning operation in which ink and bubbles are forcibly discharged from the nozzles of the recording head, the film is deformed inward and thereby reduces the volume of the ink flow passage, and the discharge of bubbles is thereby facilitated. Such a recording head can prevent the filter chamber from being blocked by bubbles accumulated in the flow passage forming member. It has been proposed to weld a film to a flow passage forming member by ultrasonic welding or thermal welding with a part of the film corresponding to a filter preliminarily bent so that the film can be easily deformed when a negative pressure acts on the film at the time of cleaning.

However, when a film is welded to a surface of the flow passage forming member with a part of the film bent toward the filter, the film is pulled toward the filter chamber and thereby sometimes wrinkled in the region other than the filter chamber. If a part of the film covering the flow passage wrinkles, bubbles may accumulate in this wrinkled part. Due to recent reduction in size of recording heads, the problem of bubbles trapped by wrinkles formed in the film is becoming pronounced.

### SUMMARY

An advantage of some aspects of the invention is to provide a liquid ejecting unit and a liquid ejecting apparatus that can prevent the film of the damper flow passage member from wrinkling.

According to an aspect of the invention, a liquid ejecting unit includes a liquid ejecting head that ejects liquid from nozzles, and a damper flow passage member that is disposed upstream of the liquid ejecting head and that receives liquid from a liquid supply source and supplies the liquid to the liquid ejecting head. A first flow passage in which a first filter that filters liquid is disposed and a second flow passage in which a second filter is disposed are formed, with an empty chamber provided therebetween, in at least one surface of the damper flow passage member. A film is attached to the at least one surface of the damper flow passage member so that the first flow passage, the second flow passage, and the empty chamber are sealed by the film independently from each other. A weak portion that permits the film to stretch is formed in a region of the film facing the empty chamber.

In the above configuration, when the film is attached to the damper flow passage member with a part of the film corresponding to the first flow passage bent inward, or when a part of the film corresponding to the first flow passage is subjected to a negative pressure and bends inward, the weak portion permits the stretching of the film, and therefore the tension can be prevented from reaching the second flow passage. Thus, the region of the film facing the second flow passage can be prevented from wrinkling. As a result, bubbles can be prevented from being trapped by wrinkles.

It is preferable that the weak portion be provided along a direction perpendicular to an arrangement direction in which the first flow passage, the second flow passage, and the empty chamber are arranged.

In the above configuration, since the weak portion is provided along a direction perpendicular to an arrangement direction in which the first flow passage, the second flow passage, and the empty chamber are arranged, the tension in the arranging direction in which the first flow passage, the second flow passage, and the empty chamber are arranged can be easily absorbed. Thus, the regions of the film facing the first flow passage and the second flow passage can be further prevented from wrinkling.

In the above configuration, the weak portion may be a slit formed along the direction perpendicular to the arrangement direction.

In the above configuration, since the weak portion is a slit formed along the direction perpendicular to the arrangement direction, the weak portion can be easily formed in the film. When a tension is applied to the film, the weak portion is easily deformed. When deformed, the weak portion does not wrinkle easily.

In the above configuration, the weak portion may be a plurality of through-holes arranged in a line along the direction perpendicular to the arrangement direction.

In the above configuration, it is preferable that the film be attached to the damper flow passage member in such a state that the region of the film facing the first flow passage can bend in response to a pressure change in the first flow passage, and the weak portion be formed at a position closer to the first flow passage than the second flow passage in the empty chamber.

In the above configuration, since the weak portion is formed at a position closer to the first flow passage than the second flow passage in the empty chamber, the region of the film facing the second flow passage can be reliably prevented from wrinkling.

A liquid ejecting apparatus according to another aspect of the invention includes a liquid ejecting unit having any one of the above-described configurations, and a liquid supply source that supplies the damper flow passage member with liquid.

### BRIEF DESCRIPTION OF THE DRAWINGS

The invention will be described with reference to the accompanying drawings, wherein like numbers reference like elements.

FIG. 1 is a plan view illustrating the configuration of a printer.

FIG. 2 is a perspective view illustrating the configuration of an ink ejecting unit.

FIG. 3 is a sectional view of the main part of a recording head.

FIG. 4 is a perspective view of a damper flow passage member.

FIG. 5 is a plan view of the damper flow passage member.

FIG. 6 is a sectional view taken along line VI-VI of FIG. 4.

FIG. 7 is a sectional view taken along line VII-VII of FIG. 4.

FIGS. 8A and 8B are enlarged views illustrating the configuration of a weak portion.

FIG. 9 is a schematic sectional view illustrating a welding step.

FIGS. 10A and 10B are enlarged views illustrating the configuration of a weak portion in another embodiment.

### DESCRIPTION OF EXEMPLARY EMBODIMENTS

The embodiments of the invention will now be described with reference to the drawings. In the embodiments described below, various limitations are made as desirable specific embodiments of the invention. However, the scope of the invention is not intended to be limited to these embodiments unless otherwise expressly stated in the following description. In addition, in these embodiments, an ink jet recording head (hereinafter referred to as “recording head”) installed in an ink jet recording apparatus that is a kind of liquid ejecting apparatus is taken as an example of a liquid ejecting head.

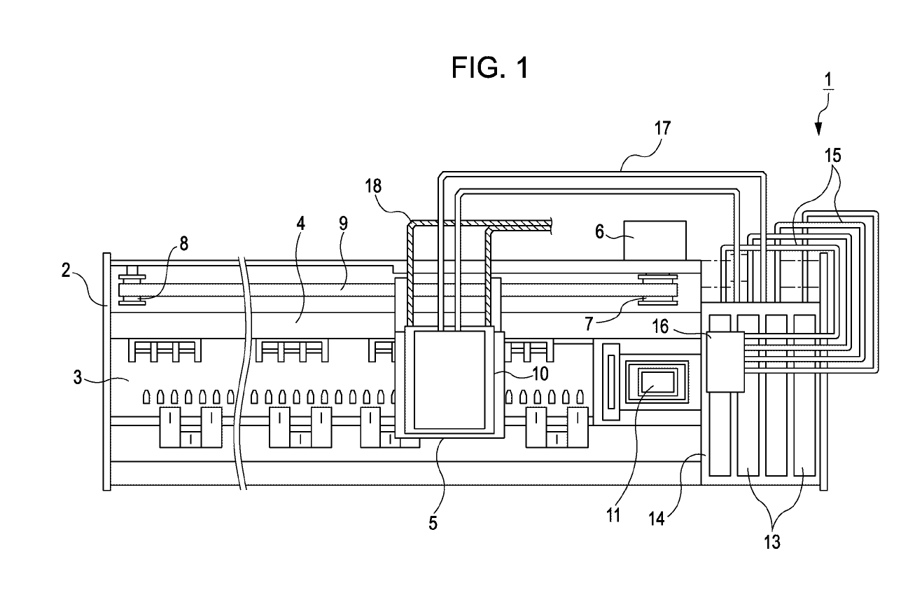

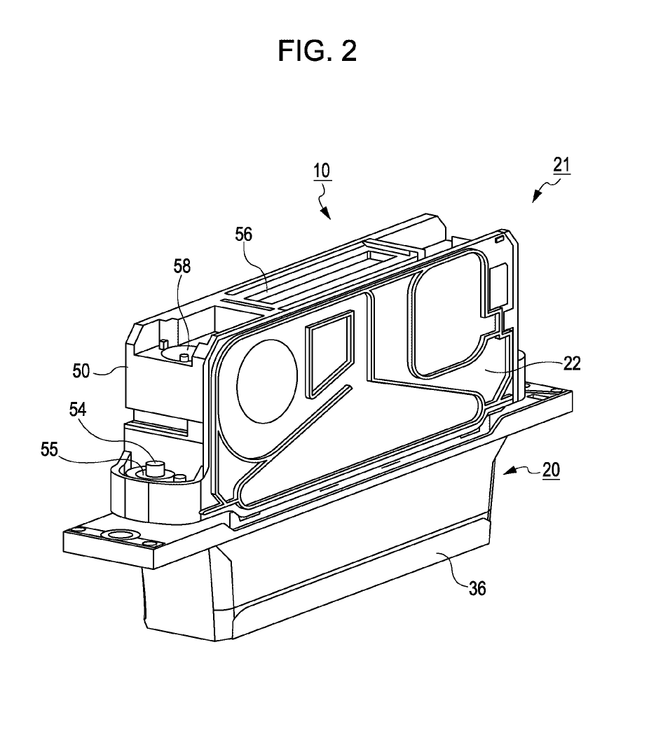

FIG. 1 is a plan view showing the configuration of an ink jet recording apparatus (hereinafter referred to as printer) equipped with an ink ejecting unit 10 (FIG. 2). The printer 1 shown as an example is an apparatus that ejects liquid ink (corresponding to liquid of the invention) onto the surface of a recording medium (landing object: not shown) such as recording paper and thereby records, for example, an image. The printer 1 has a frame 2 and a platen 3 disposed in the frame 3. Recording paper is transported onto the platen 3 by a paper feed roller (not shown) driven by a paper feed motor (not shown). In the frame 2, a guide rod 4 is disposed parallel to the platen 3. The guide rod 4 slidably supports a carriage 5 that carries an ink ejecting unit 10 having a recording head 20. The carriage 5 is connected to a timing belt 9 looped over a drive pulley 7 driven by a pulse motor 6, and an idler pulley 8 disposed on the opposite side of the frame 2 from the drive pulley 7. By driving the pulse motor 6, the carriage 5 is moved back and forth along the guide rod 4 in a main scanning direction perpendicular to the paper feed direction.

On one side of the frame 2, a cartridge holder 14 is disposed into which ink cartridges 13 (a kind of liquid supply source) are detachably loaded. The ink cartridges 13 are connected with an air pump 16 by air tubes 15. From the air pump 16, air is supplied to each ink cartridge 13. By the pressurization of the ink cartridges 13 with this air, ink is supplied (pumped) through ink supply tubes 17 to the ink ejecting unit 10.

The ink supply tubes 17 are flexible hollow members made, for example, of synthetic resin such as silicone. Inside the ink supply tubes 17, ink flow passages corresponding to the ink cartridges 13 are formed. Between the main body of the printer 1 and the ink ejecting unit 10 is laid an FFC (flexible flat cable) 18 for transmitting, for example, a drive signal from a control section (not shown) of the main body of the printer 1 to the ink ejecting unit 10.

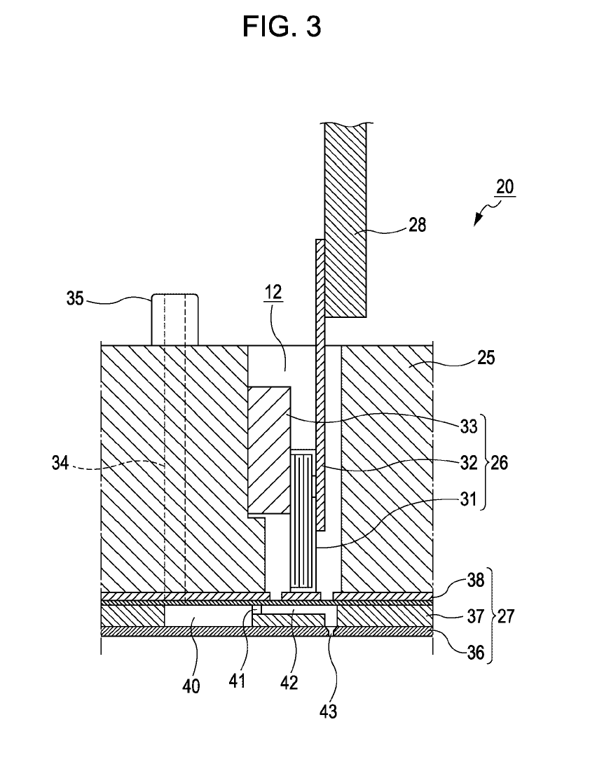

Next, the configuration of the ink ejecting unit 10 will be described. FIG. 2 is a perspective view of an ink ejecting unit 10 that is attached to the carriage 5. FIG. 3 is a sectional view of the main part of the recording head 20 of the ink ejecting unit 10. The ink ejecting unit 10 shown as an example has a recording head 20 (corresponding to a liquid ejecting head in the invention) having a nozzle forming substrate 36 in which nozzles 43 are formed, and a damper flow passage member 21 disposed above the recording head 20, that is, upstream of the recording head 20.

The recording head 20 includes a head case 25, a vibrator unit 26, a flow passage unit 27, and a drive substrate 28. The head case 25 is a hollow box-shaped member. The flow passage unit 27 is fixed to the distal end surface (lower surface) of the head case 25. The vibrator unit 26 is placed in a space 12 formed in the head case 25. On the upper surface side opposite to the distal end surface, the drive substrate 28 and the damper flow passage member 21 are disposed. The upper surface of the head case 25 is the proximal end surface of the recording head 20. Case flow passages 34 are formed through the head case 25 in its height direction. The case flow passages 34 are flow passages for supplying ink from the damper flow passage member 21 to common ink chambers 40. Two case flow passages 34 are provided for each common ink chamber 40. The recording head 20 in this embodiment has two common ink chambers 40 corresponding to two nozzle arrays (nozzle groups). A total of four case flow passages 34 are formed in the head case 25. Inlet portions 35 that are the upstream ends of the case flow passages 34 protrude from the upper surface of the head case 25. The inlet portions 35 are connected to ink inlet passages 51 of the damper flow passage member 21 through connecting holes 59.

The vibrator unit 26 includes a plurality of piezoelectric vibrators 31 arranged in a comb-like fashion, a flexible cable 32 for supplying the piezoelectric vibrators 31 with a drive signal from the drive substrate 28, and a fixing plate 33 to which the piezoelectric vibrators 31 are fixed. The piezoelectric vibrators 31 are bonded to a flexible surface (vibrating plate 38) that defines a part of each pressure chamber 42. In response to the application of drive signal, the piezoelectric vibrators 31 expand and contract and thereby increase and reduce the volume of the pressure chambers 42 and thereby cause a pressure change in ink in the pressure chambers 42. By controlling this pressure change, ink can be ejected from the nozzles 43.

The flow passage unit 27 is made by bonding together a nozzle forming substrate 36 in which nozzles 43 are provided, a flow passage forming substrate 37 that forms ink flow passages, and a vibrating plate 38 that seals the opening surface of the flow passage forming substrate 37. The flow passage unit 27 is a unit member that forms a series of ink flow passages (liquid flow passages) leading from the common ink chambers 40 through ink supply ports 41 and the pressure chambers 42 to the nozzles 43. The pressure chambers 42 branch from the common ink chambers 40. One pressure chamber 42 is formed for each nozzle 43. Ink is supplied to the pressure chambers 42 from the damper flow passage member 21 through the case flow passages 34 and the common ink chambers 40. The flow passage unit 27 is bonded to the distal end surface of the head case 25 with the nozzle forming substrate 36 facing downward (toward the platen 3 of the main body of the printer).

The flexible cable 32 is electrically connected to one end of the drive substrate 28, for example, by soldering. The FFC 18 leading from the main body of the printer is connected to the other end of the drive substrate 28. The drive substrate 28 receives a drive signal through the FFC from the control section and supplies this drive signal through the flexible cable 32 to the piezoelectric vibrator 31. The position of the drive substrate 28 is held by a substrate holding portion 56 provided in the damper flow passage member 21. The drive substrate 28 is disposed in the middle of the upper surface of the head case 25 so as to erect relative to the upper surface with the major surface parallel to the nozzle array direction.

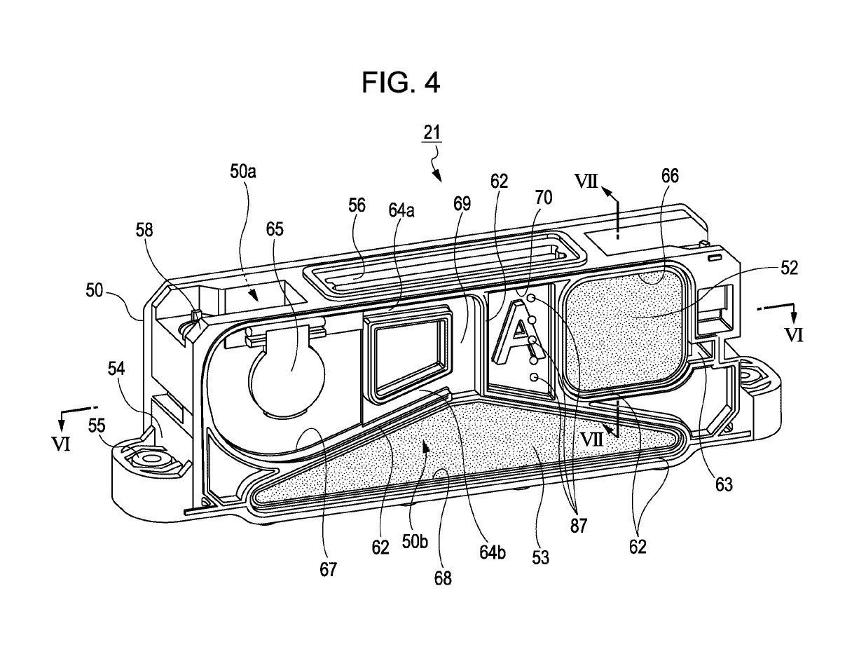

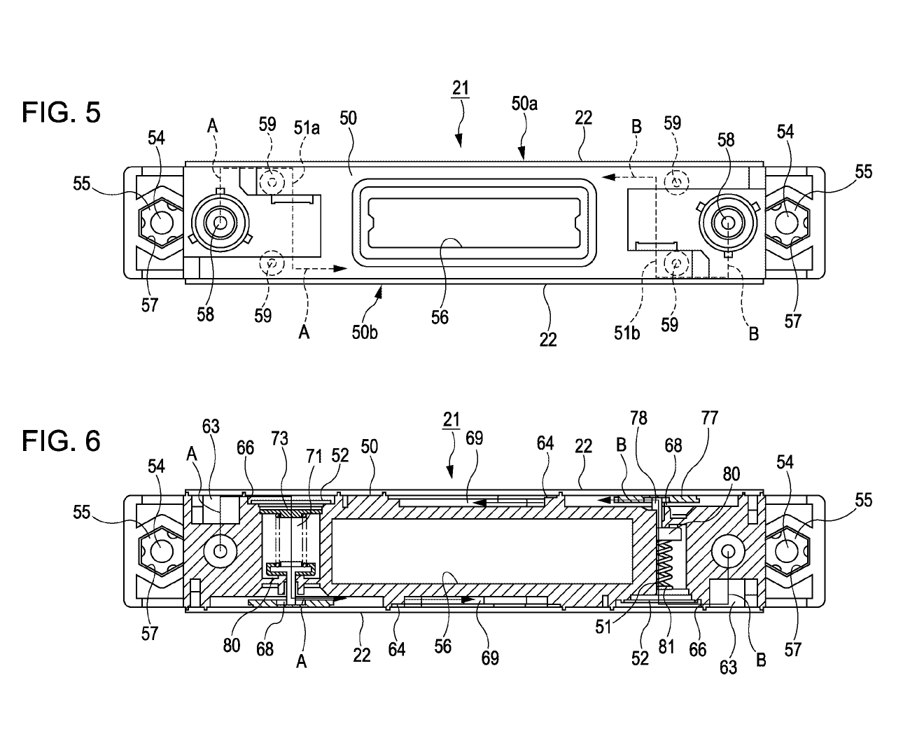

Next, the configuration of the damper flow passage member 21 that introduces ink in the ink cartridges 13 into the recording head 20 will be described. FIG. 4 is a perspective view of the damper flow passage member 21. FIG. 5 is a plan view of the damper flow passage member 21. FIG. 6 is a sectional view taken along line VI-VI of FIG. 4.

The damper flow passage member 21 mainly includes: a damper flow passage member main body 50 molded, for example, from synthetic resin into a rectangular parallelepiped shape elongated in the nozzle array direction; ink inlet passages 51 (corresponding to flow passages in the invention) formed in the inside, the first surface, and the second surface of the damper flow passage member main body 50 and supplying ink to the recording head 20; and filters 52 and 53 disposed in the ink inlet passages 51. The damper flow passage member 21 is disposed on the upper surface of the head case 25 (the proximal end surface of the recording head 20) so as to be erect relative to the nozzle surface. The damper flow passage member 21 has bolt holes 57 formed at both ends in the longitudinal direction. The damper flow passage member 21 is fixed by inserting bolts 54 into the bolt holes 57 from the recording head 20 side and then tightening nuts 55 onto the bolts 54.

The damper flow passage member main body 50 has two ink inlets 58 and a total of four connecting holes 59: a pair of connecting holes 59 for each ink inlet 58. The ink inlets 58 are formed on both sides in the longitudinal direction of the upper surface of the damper flow passage member main body 50. The ink inlets 58 are connected with the ink supply tubes 17 with packings (not shown) therebetween. The connecting holes 59 are formed on both sides in the longitudinal direction of the lower surface of the damper flow passage member main body 50. The connecting holes 59 are connected with the inlet portions 35 of the recording head 20. A series of flow passages including the ink inlet passage 51 is formed between each ink inlet 58 and corresponding connecting holes 59. That is, in the damper flow passage member main body 50 in this embodiment, two ink inlet passages 51 corresponding to two ink inlets 58 are formed independently from each other. In the middle of the damper flow passage member main body 50, a substrate holding portion 56 is provided. The substrate holding portion 56 is a through-hole in the vertical direction. The drive substrate 28 is inserted into the substrate holding portion 56 and held by the substrate holding portion 56.

Ink supplied to one of the ink inlets 58 (the left one in FIGS. 5 and 6) first flows upward in FIG. 5 through an internal flow passage 51a as indicated by arrow A in FIG. 5 and then flows through the communication hole 63 shown in FIGS. 4 and 6 into a first filter chamber 66 formed in the first surface 50a. After flowing into the first filter chamber 66, ink passes through a first filter 52 disposed in the first filter chamber 66. After being filtered, ink flows downward in FIG. 5 through the internal flow passage 51a. When a self-sealing valve 65 to be described below is open, ink flows into a pressure regulating chamber 67 formed in the second surface 50b. After flowing into the pressure regulating chamber 67, ink flows through a pair of upper and lower communication passages 64a and 64b to a vertical flow passage 69. Ink flows down the vertical flow passage 69 and flows into a second filter chamber 68. After flowing into the second filter chamber 68, ink passes through a second filter 53 provided in the second filter chamber 68. After being filtered, ink flows into two connecting holes 59 communicating with the second filter chamber 68. From the connecting holes 59 through the inlet portions 35 of the recording head 20, ink is supplied to the case flow passages 34.

Similarly, ink supplied to the other ink inlet 58 (the right one in FIGS. 5 and 6) first flows downward in FIG. 5 through an internal flow passage 51b as indicated by arrow B in FIG. 5 and then flows through the communication hole 63 into a first filter chamber 66 formed in the second surface 50b. After passing through a first filter 52, ink flows upward in FIG. 5 through the internal flow passage 51b. When a self-sealing valve 65 is open, ink flows into a pressure regulating chamber 67 formed in the first surface 50a. After flowing into the pressure regulating chamber 67, ink flows through a pair of upper and lower communication passages 64a and 64b to a vertical flow passage 69. Ink flows down the vertical flow passage 69 and flows into a second filter chamber 68. After flowing into the second filter chamber 68, ink passes through a second filter 53 provided in the second filter chamber 68. After being filtered, ink flows into two connecting holes 59 communicating with the second filter chamber 68. From the connecting holes 59 through the inlet portions 35 of the recording head 20, ink is supplied to the case flow passages 34.

In both side surfaces of the damper flow passage member main body 50, that is, the first surface 50a and the second surface 50b, surface flow passages forming a part of the ink inlet passages 51 are formed by partition portions 62 such as partition walls and partition ribs protruding from each surface. The surface flow passages formed in the surface 50a and 50b are rotationally symmetrical with respect to a central axis that passes through the center of the substrate holding portion 56 of the damper flow passage member main body 50 and is perpendicular to the upper and lower surfaces. Each surface flow passage includes a first filter chamber 66, a pressure regulating chamber 67, a vertical flow passage 69 formed along the height direction of the damper flow passage member main body 50, a pair of upper and lower communication passages 64a and 64b connecting the pressure regulating chamber 67 and the vertical flow passage 69, and a second filter chamber 68 provided downstream of the vertical flow passage 69. In this surface flow passage, the first filter chamber 66 is a part of one of the two ink inlet passages 51 and corresponds to a first flow passage in the invention. In the surface flow passage, the pressure regulating chamber 67, the communication passages 64a and 64b, the vertical flow passage 69, and the second filter chamber 68 form a part of the other ink inlet passage 51, and the vertical flow passage 69 corresponds to a second flow passage in the invention. Between the first filter chamber 66 and the vertical flow passage 69, an empty chamber 70 is provided. The empty chamber 70 is a region surrounded by partition portions 62 that define the first filter chamber 66, the vertical flow passage 69, and the second filter chamber 68. The empty chamber 70 does not communicate with either ink inlet passage 51 and is a space independent from these flow passages. That is, ink does not flow into the empty chamber 70.

To the first surface 50a and the second surface 50b of the damper flow passage member main body 50, flexible thin films 22 are bonded. The films 22 are bonded to the end faces of the partition portions 62 by thermal welding or ultrasonic welding as described blow. By the films 22, the opening surfaces of the first filter chamber 66, the pressure regulating chamber 67, the communication passages 64a and 64b, the vertical flow passage 69, the second filter chamber 68, and the empty chamber 70 are sealed. In other words, by the films 22, the first flow passage, the second flow passage, and the empty chamber 70 are sealed independently from each other.

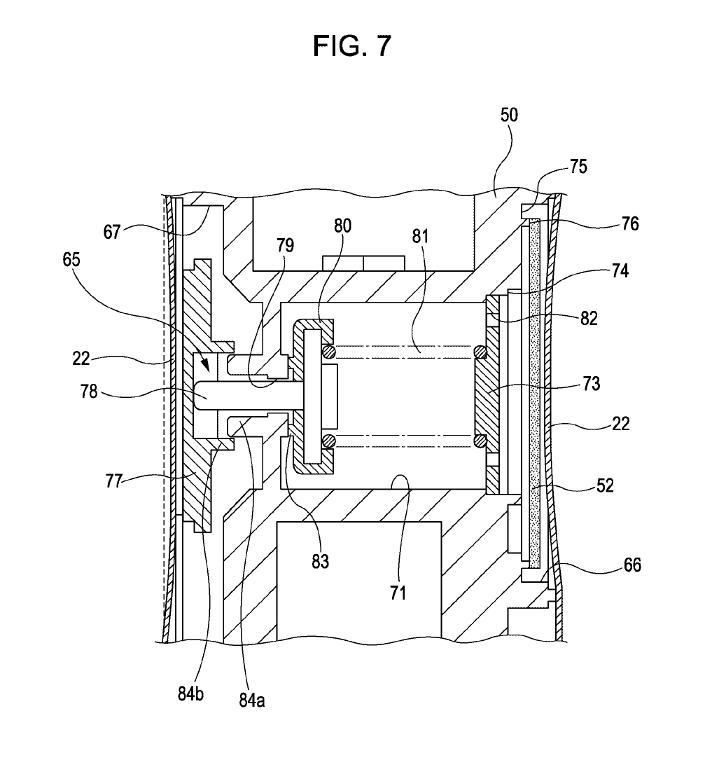

FIG. 7 is a sectional view taken along line VII-VII of FIG. 4. The first filter chamber 66 is an empty portion that is substantially rectangular in plan view and communicates with the pressure regulating chamber 67 provided in the opposite surface through a communication empty portion 71. The first filter chamber 66 is disposed upstream of the second filter chamber 68 in the ink inlet passage 51. At the bottom of the first filter chamber 66, a spring seat attaching stepped portion 74 and a filter attaching stepped portion 75 are formed. A spring seat 73 is attached to the spring seat attaching stepped portion 74 so as to cover the communication empty portion 71. The filter attaching stepped portion 75 is located outside the spring seat attaching stepped portion 74 in the planar direction and is shallower than the spring seat attaching stepped portion 74. In the filter attaching stepped portion 75, a filter attaching rib 76 is formed like a frame along the planar shape of the first filter chamber 66. The first filter 52 is fixed by welding to the end face of the filter attaching rib 76 so as to be parallel to both side surfaces of the damper flow passage member main body 50. The pressure regulating chamber 67 is an empty portion in which a pressure receiving plate 77 to be described below is placed. At the bottom of the pressure regulating chamber 67, an insertion hole 79 is provided into which a shaft portion 78 of the self-sealing valve 65 is inserted.

The self-sealing valve 65 will be described. The recording head 20 ejects ink from the nozzles 43, and the pressure in the common ink chambers 40 is thereby lowered. When the pressure in the damper flow passage member 21 becomes lower than the outside atmospheric pressure, the self-sealing valve 65 opens and permits ink to flow from the first filter chamber 66 to the pressure regulating chamber 67. That is, when ink is supplied from the ink inlet 58 at a predetermined pressure and when sufficient ink is accumulated in the common ink chambers 40 of the recording head 20, the self-sealing valve 65 is closed. When ink is ejected from the nozzles 43 and the pressure on the downstream side of the self-sealing valve 65 is thereby lowered, a negative pressure is created. Due to this negative pressure, the self-sealing valve 65 is opened, and ink is supplied.

As shown in FIG. 7, the self-sealing valve 65 in this embodiment has a shaft portion 78 and a disk portion 80 formed at one end of the shaft portion 78 integrally with the shaft portion 78. The shaft portion 78 is inserted into the insertion hole 79 formed in the pressure regulating chamber 67. The disk portion 80 is placed in the communication empty portion 71 together with a spring 81 to be described below. On the insertion hole 79 side of the disk portion 80, around the insertion hole 79, a protruding portion 83 is provided so as to be convex toward the insertion hole 79. One end of a spring 81 (a kind of urging member) is connected to the back surface (the first filter 52 side surface) of the disk portion 80. The other end of the spring 81 is connected to the spring seat 73. As described above, the spring seat 73 is fixed to the bottom of the first filter chamber 66, and the spring seat 73 has through-holes 82 formed therein through which ink can flow. The spring 81 urges the self-sealing valve 65 toward the film 22. When the pressure in the pressure regulating chamber 67 is not significantly lower than the outside atmospheric pressure, the urging force of the spring 81 presses the protruding portion 83 of the disk portion 80 against the periphery of the insertion hole 79 and keeps the self-sealing valve 65 closed. The pressure regulating chamber 67 is provided with a pressure receiving plate 77. The pressure receiving plate 77 is in contact with the shaft portion 78. In this embodiment, the pressure receiving plate 77 is not fixed to the film 22. That is, in this embodiment, when the film 22 is displaced toward the first filter 52 with decreasing pressure, the film 22 comes into contact with the pressure receiving plate 77, and the pressure receiving plate 77 is displaced toward the first filter 52 together with the film 22. Being displaced, the pressure receiving plate 77 comes into contact with the self-sealing valve 65 and moves the self-sealing valve 65.

Since the pressure receiving plate 77 is not fixed to the film 22 in this embodiment, a limiting member 84a that limits the displacement of the pressure receiving plate 77 is provided in the pressure regulating chamber 67, like a wall surface around the insertion hole 79, in order to stably displace the pressure receiving plate 77. A limiting member 84b that is fitted onto the limiting member 84a is provided on the limiting member 84a side of the pressure receiving plate 77, so as to surround the limiting member 84a, around the limiting member 84a. That is, when the pressure receiving plate 77 operates, the limiting member 84b is fitted onto the limiting member 84a, and the pressure receiving plate 77 can operate stably. Thus, the self-sealing valve 65 can be stably operated. In this case, the limiting members 84a and 84b are each provided with a slit-like opening (not shown). When the self-sealing valve 65 is open, ink can flow through the slit-like openings.

When a negative pressure acts on the pressure regulating chamber 67, that is, when the pressure in the pressure regulating chamber 67 becomes lower than the outside atmospheric pressure due to the ejection of ink, the film 22 is displaced toward the first filter 52 and moves the pressure receiving plate 77 and the self-sealing valve 65 toward the first filter 52 against the urging force of the spring 81, thereby opening the self-sealing valve 65. Thus, ink is permitted to flow from the first filter chamber 66 to the pressure regulating chamber 67.

The film 22 seals the first filter chamber 66 in which the first filter 52 is placed. The region of the film 22 facing the first filter chamber 66 is also bent toward the first filter 52 when a negative pressure does not act on it (or a low negative pressure acts on it). In other words, the region of the film 22 facing the first filter chamber 66 is curved when a negative pressure does not act on it (or a low negative pressure acts on it). Since the region of the film 22 facing the first filter chamber 66 is also bent as described above, bubbles can be prevented from remaining in the first filter chamber 66 after a cleaning operation in which a negative pressure is applied to the nozzles 43 of the recording head 20 and ink and bubbles are forcibly discharged from the nozzles 43.

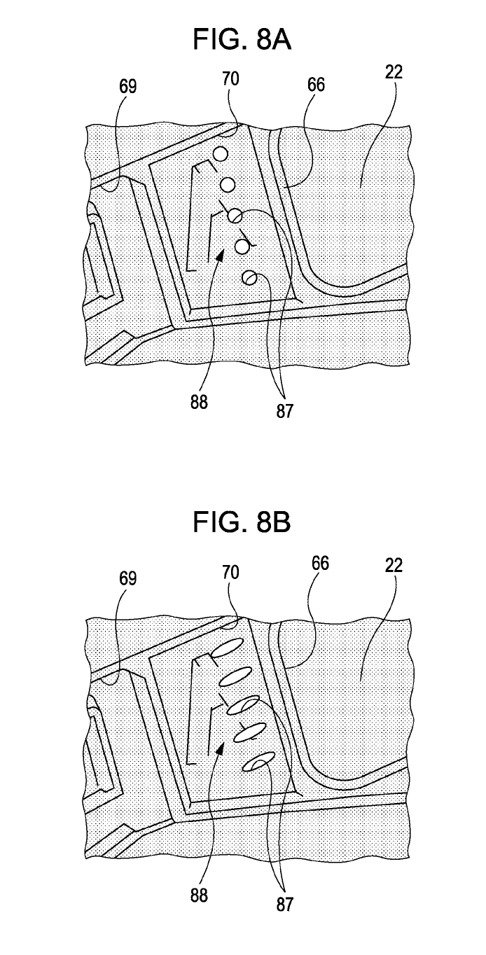

In the region of the film 22 facing the empty chamber 70, as shown in FIG. 8A, a weak portion 88 that permits the stretching of the film 22 is formed along the vertical direction, that is, the direction perpendicular to the arrangement direction (horizontal direction) in which the first filter chamber 66 as a first flow passage, the vertical flow passage 69 as a second flow passage, and the empty chamber 70 are arranged. The weak portion 88 in this embodiment is a plurality of through-holes 87 arranged in the vertical direction. In the region corresponding to the empty chamber 70, the through-holes 87 are provided at a position closer to the first filter chamber 66 than the vertical flow passage 69. The parts of the film 22 between adjacent through-holes 87 are weaker than the other part. Since such weak portions 88 are provided, as described below, when the films 22 are welded to both surfaces of the damper flow passage member main body 50, or when the region of each film 22 corresponding to the first filter chamber 66 bends toward the first filter 52, as shown in FIG. 8B, the weak parts between adjacent through-holes 87 are deformed, and the stretching of the film 22 is thereby permitted. In FIG. 4, the film 22 is not shown, but the through-holes 87 forming the weak portion 88 are shown.

When bubbles trapped by the first filter 52 accumulate and block the first filter 52 in the first filter chamber 66, the effective area of the first filter 52 decreases. So, the printer 1 regularly performs cleaning for discharging bubbles as described above. This cleaning is performed as follows. First, the ejection-side surface of the nozzle forming substrate 36 of the recording head 20 is sealed, for example, with a cap member 11. A pump is brought into operation, and a negative pressure is created in the cap member 11. The negative pressure acts on the nozzles 43, and ink is sucked out from the nozzles 43. Thus, bubbles are removed. In this case, in order to reduce the bubbles generated after cleaning, it is effective to reduce the volume of the first filter chamber 66 at the time of cleaning. The reason is that when ink is sucked from the first filter chamber 66 at the time of cleaning, air existing in the first filter chamber 66 becomes bubbles after cleaning. For this reason, in this embodiment, by preliminarily bending the region of the film sealing the first filter chamber 66 when a negative pressure does not act on it (or a low negative pressure acts on it), the volume of the first filter chamber 66 (the volume of the space defined by the first filter chamber 66 and the film 22) can be made small at the time of cleaning compared to a known damper flow passage member in which a tension is applied to the region of the film sealing the first filter chamber. In a known damper flow passage member, a tension is applied to the region of the film sealing the first filter chamber. Therefore, when a negative pressure acts on the film at the time of cleaning, the film does not bend to the downstream side easily. The volume of the first filter chamber at the time of cleaning is almost the same as that at normal times. In contrast, in this embodiment, since the region of the film sealing the first filter chamber 66 is bent before a negative pressure is applied, the film 22 bends to the downstream side (the first filter 52 side) easily at the time of cleaning. In addition, since the film 22 is bent, the film 22 is not easily subjected to reaction force compared to the case where a tension is applied to the film, and the film 22 bends to the downstream side more easily. Thus, the volume of the first filter chamber 66 can be made small compared to a known damper flow passage member, and the bubbles remaining after cleaning can be reduced. Therefore, the first filter 52 can be used effectively. In this embodiment, as described above, a weak portion 88 is formed in a region of the film 22 facing the empty chamber 70. At the time of cleaning, a negative pressure acts on the region of the film 22 facing the first filter chamber 66 and bends the film 22 toward the first filter 52. Even if the whole film 22 is pulled toward the first filter chamber 66, the deformation of the film 22 is permitted by the weak portion 88, and therefore the tension does not reach the vertical flow passage 69 easily. Therefore, the region of the film 22 corresponding to the vertical flow passage 69 does not wrinkle easily. As a result, bubbles in the vertical flow passage 69 are prevented from being trapped by wrinkles, and bubbles in the vertical flow passage 69 can be effectively discharged at the time of cleaning. Since the through-holes 87 of the weak portion 88 are provided along the direction perpendicular to the arrangement direction (horizontal direction) in which the first filter chamber 66 as a first flow passage, the vertical flow passage 69 as a second flow passage, and the empty chamber 70 are arranged (the horizontal direction), the tension in the arrangement direction can be easily absorbed. Thus, the formation of wrinkles can be prevented more reliably.

The region of the film 22 sealing the first filter chamber 66 needs to be bent in a state where a negative pressure does not act on it (or a low negative pressure acts on it). Otherwise, the film 22 cannot bend to the first filter chamber 66 side so as to reduce the volume of the first filter chamber 66 at the time of cleaning as described above. So, when the film 22 is welded to the damper flow passage member main body 50, the region of the film 22 facing the first filter chamber 66 is bent. A detailed description will be given below.

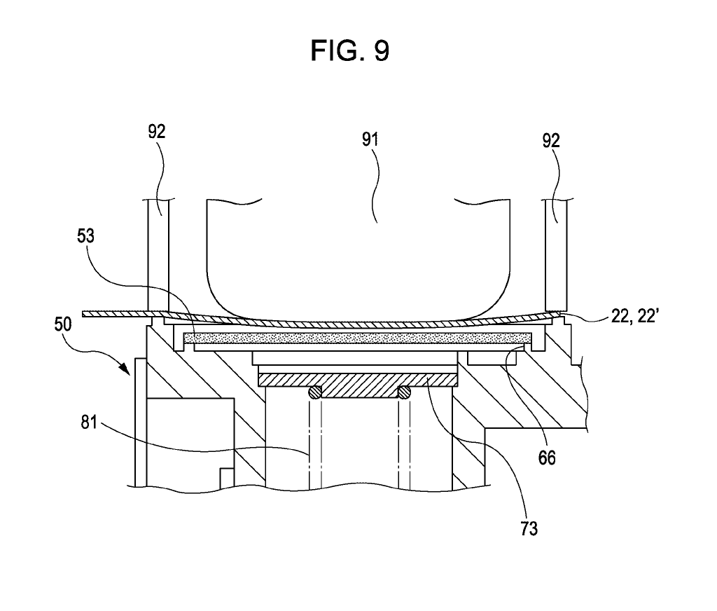

First, as shown in FIG. 9, the damper flow passage member main body 50 is placed in a jig (not shown), and a film base material 22′ is positioned relative to the damper flow passage member main body 50 and placed on the jig (placing step). A region of the film base material 22′ having substantially the same shape as the side surface of the damper flow passage member main body 50 is surrounded by perforations (not shown). In the region of the film base material 22′ facing the empty chamber 70, a weak portion 88 is preliminarily formed by forming through-holes 87 by punching. The film base material 22′ is positioned on the jig using a positioning pin (not shown) so that the region surrounded by perforations is aligned with the side surface of the damper flow passage member main body 50. After that, the part of the film base material 22′ corresponding to the first filter chamber 66 is bent toward the first filter 52 (film deforming step). The film base material 22′ in this state is welded (fixed) to the side surface of the damper flow passage member main body 50 (welding step). That is, as shown in FIG. 9, the film base material 22′ is pressed by a pressing member 91 so as to be bent toward the first filter 52, and the region to be welded is covered by a heating member 92. The film base material 22′ is heated by the heating member 92 and welded to the partition portion 62 of the side surface. Thus, the film base material 22′ is welded with the region sealing the first filter chamber 66 bent. In this way, the region of the film 22 sealing the first filter chamber 66 can be bent in a state where a negative pressure does not act on it (or a low negative pressure acts on it).

In this case, when the whole film is welded to the side surface of the damper flow passage member main body with the part of the film base material 22′ corresponding to the first filter chamber 66 bent, the other part of the film base material 22′ is pulled toward the first filter chamber 66 and wrinkles easily. If the part of the film corresponding to the flow passage wrinkles, bubbles accumulate in this wrinkled part. In this embodiment, a weak portion 88 is formed in the region of the film 22 facing the empty chamber 70. Therefore, at the time of welding, even if the region of the film 22 facing the first filter chamber 66 bends toward the first filter 52, the deformation of the film 22 is permitted by the weak portion 88. Therefore, the tension when the film is pulled does not easily reach the vertical flow passage 69. For this reason, the region of the film 22 corresponding to the vertical flow passage 69 does not wrinkle easily. As a result, bubbles in the vertical flow passage 69 are prevented from being trapped by wrinkles. In this embodiment, the weak portion 88 is a plurality of through-holes 87. When the whole film is welded to the damper flow passage member main body 50 with the part of the film base material 22′ corresponding to the first filter chamber 66 bent, the weak parts between adjacent through-holes 87 are deformed, and the vicinities of the through-holes 87 may thereby be wrinkled. As described above, in the region corresponding to the empty chamber 70, the through-holes 87 are provided at a position closer to the first filter chamber 66 than the vertical flow passage 69. Therefore, the wrinkles near the through-holes 87 are prevented from reaching the vertical flow passage 69.

After that, the pressing member 91 and the heating member 92 are removed, and the film base material 22′ is removed with the region surrounded by perforations left. The damper flow passage member 21 in which a film 22 is fixed to the damper flow passage member main body 50 and the part of the film 22 corresponding to the first filter chamber 66 is bent is removed from the jig. This completed damper flow passage member 21 is placed on the recording head 20 so that the liquid supply passages communicate with the head flow passages.

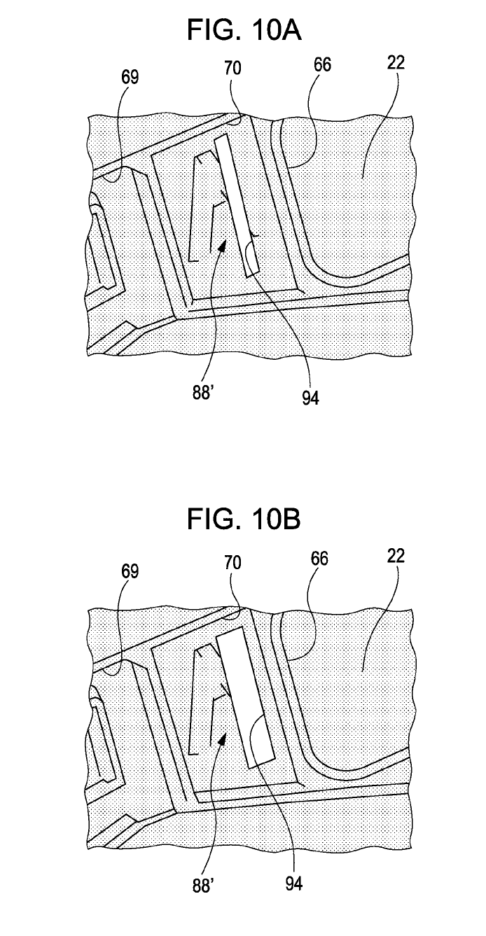

FIGS. 10A and 10B illustrate the configuration of a weak portion 88′ in another embodiment of the invention. This embodiment differs from the first embodiment described above in that the weak portion 88′ is a slit 94 extending along the vertical direction, that is, the direction perpendicular to the arrangement direction (horizontal direction) in which the first filter chamber 66 as a first flow passage, the vertical flow passage 69 as a second flow passage, and the empty chamber 70 are arranged. Other configurations are the same as those of the first embodiment, so the description thereof will be omitted. Since the weak portion 88′ is a slit 94, the weak portion 88′ can be deformed more easily than the through-holes 87 and does not wrinkle easily when deformed. In addition, when the slit 94 is formed in the film 22, problems caused by punching debris can be prevented, compared to the case where a plurality of through-holes 87 are formed.

Examples of weak portions are not limited to those shown in the above-described embodiments as long as they are weaker and more deformable than the other part of the film 22. That is, instead of making through-holes 87 or a slit 94 through the film 22, the thickness of the film 22 may be partially reduced to make a weak portion.

Although a description has been given of a printer 1, a kind of liquid ejecting apparatus, the invention can also be applied to other liquid ejecting apparatuses. The invention can also be applied, for example, to: a display manufacturing apparatus for manufacturing a color filter of a liquid crystal display or the like; an electrode manufacturing apparatus for forming electrodes of an organic EL (Electro Luminescence) display, an FED (Field Emission Display), or the like; and a chip manufacturing apparatus for manufacturing biochips (biochemical elements).

What is claimed is:

1. A liquid ejecting unit comprising:
a liquid ejecting head for ejecting liquid from nozzles; and
a damper flow passage member that supplies the liquid to the liquid ejecting head,
wherein the damper flow passage member includes:
a first flow passage having a first filter;
a second flow passage having a second filter; and
an empty chamber provided between the first flow passage and the second flow passage,
the first flow passage, the second flow passage and the empty chamber are sealed by a film, and
the film has a through-hole in a region facing the empty chamber.

2. The liquid ejecting unit according to claim 1, wherein the through-hole is provided along a direction perpendicular to an arrangement direction in which the first flow passage, the second flow passage, and the empty chamber are arranged.

3. The liquid ejecting unit according to claim 2, wherein the through-hole is a slit formed along the direction perpendicular to the arrangement direction.

4. The liquid ejecting unit according to claim 2, wherein the film has a plurality of through-holes arranged in a line along the direction perpendicular to the arrangement direction.

5. The liquid ejecting unit according to claim 4, wherein the film is attached to the damper flow passage member in such a state that the region of the film facing the first flow passage can bend in response to a pressure change in the first flow passage, and the through-hole is formed at a position closer to the first flow passage than the second flow passage in the empty chamber.

6. A liquid ejecting apparatus comprising the liquid ejecting unit according to claim 1.
